(19) United States
(12) Patent Application Publication
(10) Pub. No.: US 2023/0325896 A1
(43) Pub. Date: Oct. 12, 2023

(54) Entity Interoperability for Digital Items in a Metaverse

(71) Applicant: Meta Platforms Technologies, LLC, Menlo Park, CA (US)

(72) Inventor: Matthew LUKER, Port Angeles, WA (US)

(21) Appl. No.: 17/716,484

(22) Filed: Apr. 8, 2022

(51) Int. Cl. G06Q 30/06; G06Q 50/00

(52) U.S. Cl. CPC G06Q 30/0603; G06Q 50/01

(57) ABSTRACT

A digital item interoperability system can be implemented across publisher, marketplace, inventory and environment entities, allowing digital items to be created by different creators, acquired from different listings, tracked outside a central system, and used in a variety of environments making up a metaverse. When a user acquires a digital item, it can be added to one of various inventory services and when the user enters an environment, the environment can define which of the user's digital items in the inventory that environment supports and bring the supported digital items into the environment. This allows a digital items life-cycle and usage to be independent of not just where it was made or acquired, but also from specific environments. A creator can create digital items, the digital items can be used with any number of environments, and the digital items can be listed with any number of marketplaces.

### TECHNICAL FIELD

The present disclosure is directed to establishing interoperability in network interactions between multiple digital entities to allow digital items to be created, acquired, and used in a variety of environments making up a metaverse.

### BACKGROUND

Most current multi-user digital environments are closed systems in which a single entity is in charge of creating the environment, providing user experiences, and providing digital items with which users can interact within the environment. Examples of such a closed environments are multiplayer video games and VR chat rooms. Users in these environments can, for example, select from a defined set of options to customize their appearance, interact with each other, and acquire items within the environment. However, unless the user is moving to another environment implemented by the same entity, these specifications and acquisitions are relegated to the environment in which they were performed.

In the current digital world, users often make significant investments (e.g., through time, experience, and/or funds) to acquire an array of digital items such as clothing, accessories, tools, weapons, vehicles, special abilities, etc. For example, according to one report, in-game purchases of digital items in 2021 were over 61 billion dollars. However, nearly all of these digital items were provided for use in closed systems, where they were provided by a single entity and were only useable in the environment for which they were created.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIGS. 3A-3D are block diagrams illustrating components which, in some implementations, can be used in a system employing the disclosed technology.

FIG. 4 is a flow diagram illustrating a process used in some implementations for a publisher entity to create and administer digital items for a metaverse.

FIG. 5 is a flow diagram illustrating a process used in some implementations for a marketplace entity to list digital items for a metaverse.

FIG. 6 is a flow diagram illustrating a process used in some implementations for an inventory entity to provide ownership data for digital items for a metaverse.

FIG. 7 is a flow diagram illustrating a process used in some implementations for an environment entity to instantiate digital items into an artificial reality environment for a metaverse.

FIG. 8 is a conceptual diagram illustrating an example of interactions between publishing, marketplace, inventory, and environment entities for digital items in a metaverse.

FIGS. 9A and 9B are conceptual diagrams illustrating examples of a digital item instantiated in two different artificial reality environments in a metaverse.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to making a digital item interoperability system that can be implemented across publisher, marketplace, inventory and environment entities to allow digital items to be created by different creators, acquired from different listings, tracked outside a central system, and used in a variety of environments making up a metaverse. Thus, no single entity will be in charge of digital item publication, market listing, or inventory tracking, yet digital items will be useable in multiple different environments implemented by different entities. By separating the definition of a digital item from how it is created, listed, and instantiated in an environment, digital item creators can create and publish digital items to multiple marketplaces. When a user acquires a digital item, it can be added to one of various inventory services and when the user enters an environment, the environment can define which of the digital items owned by the user that environment supports and query the inventory, thus bringing the user's digital items into the environment. This allows a digital item's life-cycle and usage to be independent of not just where it was made or acquired, but also from specific environments. A creator can create digital items, the digital items can be used with any number of environments, and the digital items can be listed (or not) with any number of marketplaces.

In particular, a publisher entity can implement a digital item interoperability system to receive a digital item definition from a creator. The digital item definition can specify item assets (such as one or more 3D models, 2D images, animation, text, audio, etc.); item characteristics and abilities (e.g., variables and functions that define how the digital item can be placed/used, how the digital item interacts with other real and virtual objects, how the digital item changes when in different contexts, etc.); and metadata for the digital item (e.g., name, type, creator ID, dimensions, ecosystems in which the digital item can or cannot be used, limits on who can own the digital item or how it can be acquired, etc.) In some implementations, a digital item definition can include portions that have versions for different metaverse ecosystems. An ecosystem is a portion of a metaverse where a common digital item data structure is used, which may be due to an entity (e.g., organization, company, government, etc.) facilitating multiple artificial reality environments or multiple environment facilitating entities agreeing on a digital item data structure standard. However, a metaverse may have multiple ecosystems in which a digital item data structure used in one artificial reality environment may not be compatible with another artificial reality environment. The digital item definition, however, can have data applicable to multiple ecosystems, thus by applying the digital item definition to a set of templates for a given ecosystem, the digital item definition can be used to generate a corresponding digital item data structure for that ecosystem. The publisher can also perform various validations and safety checks on of the digital item data structure according to policies specified by the corresponding ecosystem. The assets for the digital item can be stored in a content delivery network (CDN), maintained by the publisher or another cloud storage system, that the digital item data structure links to, allowing digital item assets to be retrieved for instantiation. The publisher can send information about the digital item to one or more marketplaces to create listings and operate user acquisition for the digital item.

The marketplace entity can implement a digital item interoperability system to receive, from a publisher, information for a digital item, which may include the full digital item data structure or certain portions needed for a listing such as the title, sample images or models, identifications of which ecosystems in which the digital item can be used, who the digital item creator is, digital item validations, cost, size, etc. The marketplace entity can use this information in various templates to create a digital item listing which users can view and interact with to acquire possession of the digital item. This can include performing financial transactions and supplying ownership information, for the digital item, to an inventory entity used by the acquiring user.

The inventory entity can implement a digital item interoperability system to track items owned (or otherwise have rights to use) by various users. The users can establish sets of items or otherwise define rules for selecting items that should be shared with various environments or environment types. For example, a user can set a first list of items to be shared with an environment the user has designated as work and a second list of items to be shared with an environment the user has designated as family. As another example, the user can setup a first rule to allow only items with a particular “PG” rating for all environments that are open to the general public and has setup a second rule allowing all her items to be shared with an environment she has setup for her and her close friends.

The environment entity can implement a digital item interoperability system to instantiate items from different creators, using different publishers, marketplaces, and inventories. The environment entity can receive an identification of a user entering an artificial reality environment operated by that environment entity and a designation of an inventory service used by that user. The environment entity can contact the inventory entity, supplying the user ID and other credentials, and receive back a list of digital items the user has authorized to be available to the environment entity. The environment entity can then evaluate each of the items to determine whether it will allow each to be instantiated in its artificial reality environment. This can include checking compatibility of the digital item data structure, checking or modifying display properties of the digital item, checking or modifying display abilities of the digital item, etc. For each digital item that can be instantiated in the artificial reality environment, the environment can execute that instantiation (including any necessary modifications) and provide the instantiated digital item to the user in the artificial reality environment.

Existing multi-user environments are closed systems where a digital item acquired in that environment cannot be instantiated in other environments. A user may purchase an item or spend significant time acquiring an item, but when the user goes to another environment, she cannot take the item with her. This presents several problems. For example, when the same entity provides the publishing, marketplace, and inventory functions, this can create significant resource concentration and network bottlenecks. In addition, only the entity that implemented the environment can create digital items for that environment, which limits the diversity of items available, provides monopolies for the environment implementer, and limits outlets for content creators. Further, when there is only a single marketplace, unwanted controls can be implemented such as excessive fees and censorship on what types of digital items can be provided. Yet further, when items cannot be transferred between environments, users may be more hesitant to acquire them, their value is decreased, and significant resources have to be expended to create similar items for other environments.

The digital item interoperability systems and methods described herein are expected to overcome these issues with existing systems by establishing interoperability in network interactions between multiple digital entities to allow digital items to be created, acquired, and used in a variety of environments making up a metaverse. By having multiple publisher, marketplaces, and inventories, the computational load for performing these services can be distributed and network traffic can flow to the various providers without creating severe bottlenecks. In addition, the digital items available can be much more varied and useful as digital items are not limited to a single environment or ecosystem. Further, creators can select from among multiple publishers and marketplaces, and users can select from among multiple inventories, providing competition and market pressures to avoid consumer abuses. Also, users are more likely to acquire digital items that have use across multiple ecosystems and may be willing to pay more for them. In addition, digital items being useable in multiple ecosystems reduces computational load and human resources required to create unique digital items for each ecosystem.

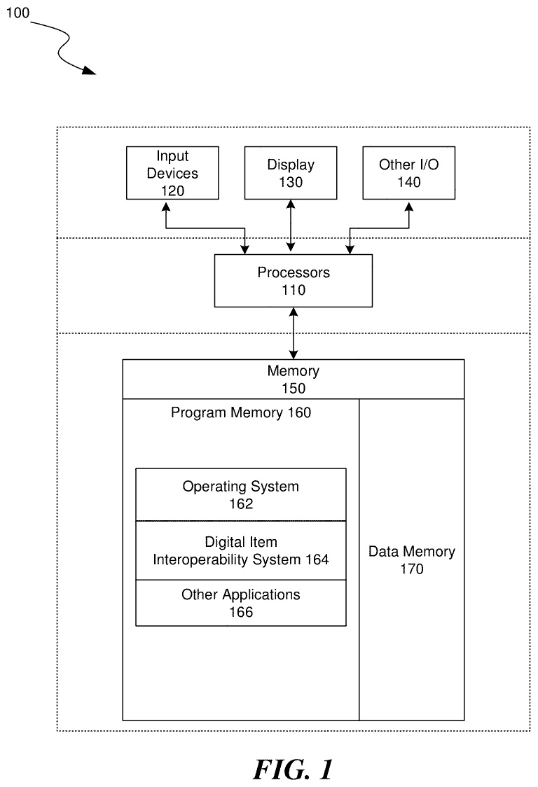

Several implementations are discussed below in more detail in reference to the figures. FIG. 1 is a block diagram illustrating an overview of devices on which some implementations of the disclosed technology can operate. The devices can comprise hardware components of a device 100 that can establish interoperability in network interactions between multiple digital entities to allow digital items to be created, acquired, and used in a variety of environments making up a metaverse. Device 100 can include one or more input devices 120 that provide input to the Processor(s) 110 (e.g., CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera- or image-based input device, a microphone, or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, digital item interoperability system 164, and other application programs 166. Memory 150 can also include data memory 170, e.g., digital item definitions, digital item data structure templates for various ecosystems, validation and safety policies, digital item data structures and assets, digital item listings, digital item ownership information, digital item environment authorizations, digital item instantiation rules and transformations, configuration data, settings, user options or preferences, etc., which can be provided to the program memory 160 or any element of the device 100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

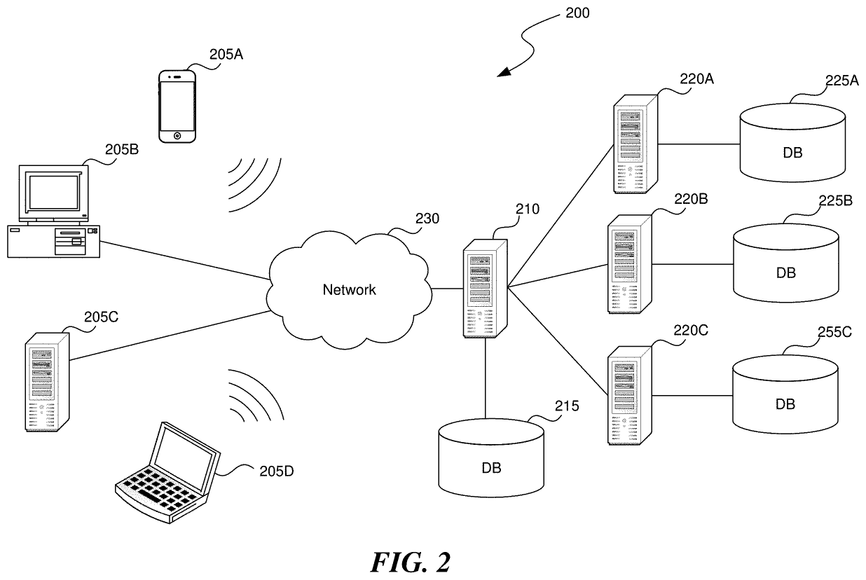

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g., store) information. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

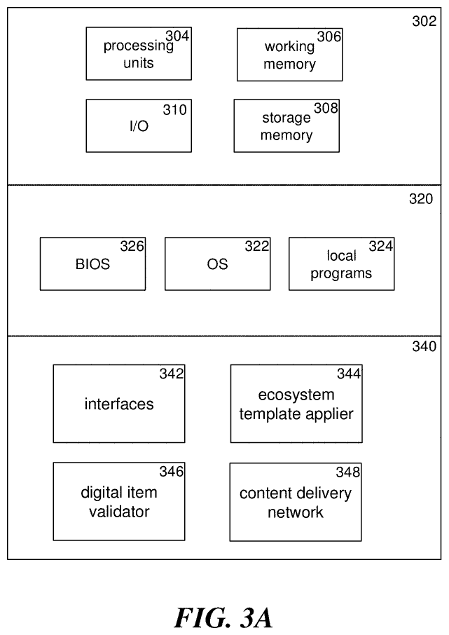

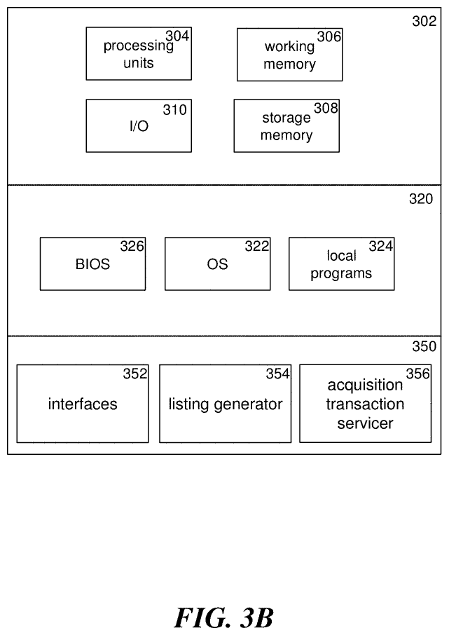

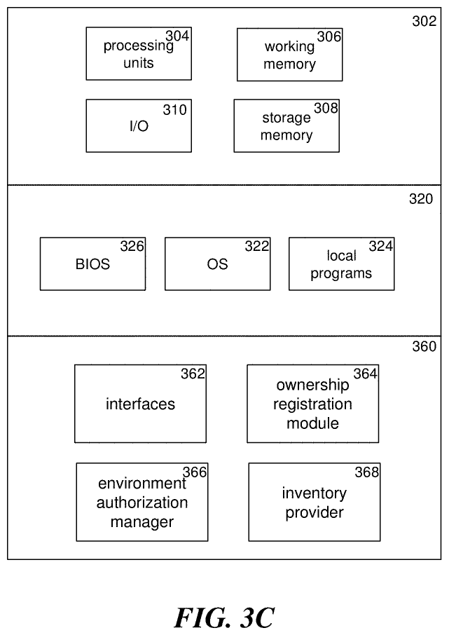

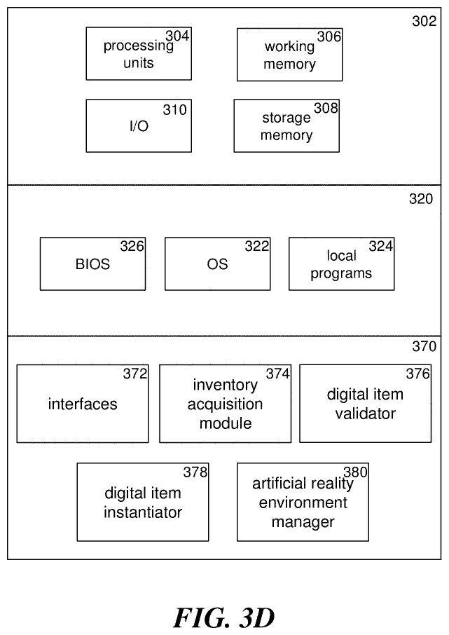

FIGS. 3A-D are block diagrams illustrating components which, in some implementations, can be used in a system employing the disclosed technology. FIG. 3A is a block diagram illustrating components for a publisher entity. FIG. 3B is a block diagram illustrating components for a marketplace entity. FIG. 3C is a block diagram illustrating components for an inventory entity. FIG. 3D is a block diagram illustrating components for an environment entity. Each of the sets of components in FIGS. 3A-3D can include similar hardware 302 and general software 320. As discussed above, a system implementing the disclosed technology can use various hardware including processing units 304 (e.g., CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g., a redundant array of independent disks (RAID)) accessible through a system bus or can be a cloud storage provider or other network storage accessible via one or more communications networks (e.g., a network accessible storage (NAS) device, such as storage 215 or storage provided through another server 220). The components can be implemented in a client computing device such as client computing devices 205 or on a server computing device, such as server computing device 210 or 220. General software 320 can include various applications including an operating system 322, local programs 324, and a basic input output system (BIOS) 326.

In FIG. 3A, specialized components 340, for a publisher entity, can include ecosystem template applier 344, digital item validator 346, CDN 348, and components which can be used for providing user interfaces, transferring data, and controlling the specialized components, such as interfaces 342.

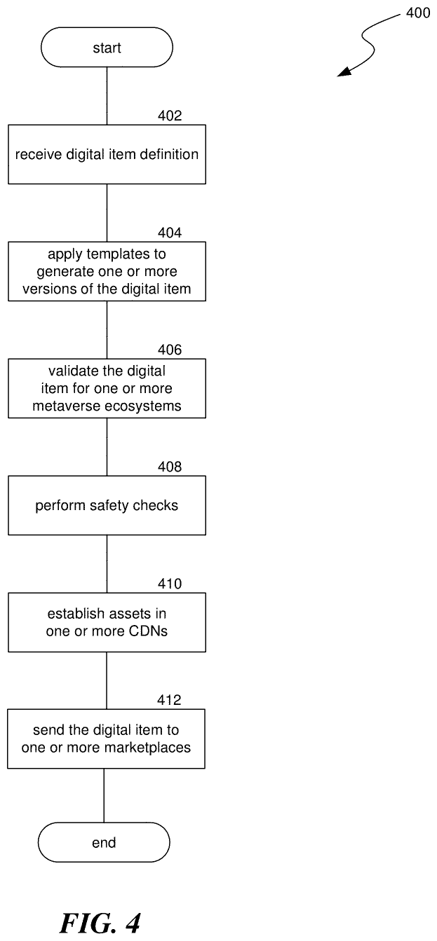

The ecosystem template applier 344 can receive a digital item definition from a digital item creator, via interfaces 342, and apply a set of templates, for one or more ecosystems specified by the digital item creator, to produce digital item data structures. Additional details on generating digital item data structures by applying templates to digital item definitions are provided below in relation to blocks 402 and 404 of FIG. 4.

The digital item validator 346 can, for each ecosystem the digital item will be created for, apply a set of validation rules and safety checks for technical, functional, and appropriateness compatibility of the digital item with that ecosystem. Additional details on validating digital item data structures are provided below in relation to blocks 406 and 408 of FIG. 4.

The CDN 348 can receive, via interfaces 342, a set of assets for a digital item, which the CDN 348 can index to the digital item identifier and then serve to entities (e.g., environments, marketplaces, etc.) upon request. Additional details on CDNs storing digital item assets are provided below in relation to block 410 of FIG. 4.

In FIG. 3B, specialized components 350, for a marketplace entity, can include listing generator 354, acquisition transaction servicer 356, and components which can be used for providing user interfaces, transferring data, and controlling the specialized components, such as interfaces 352.

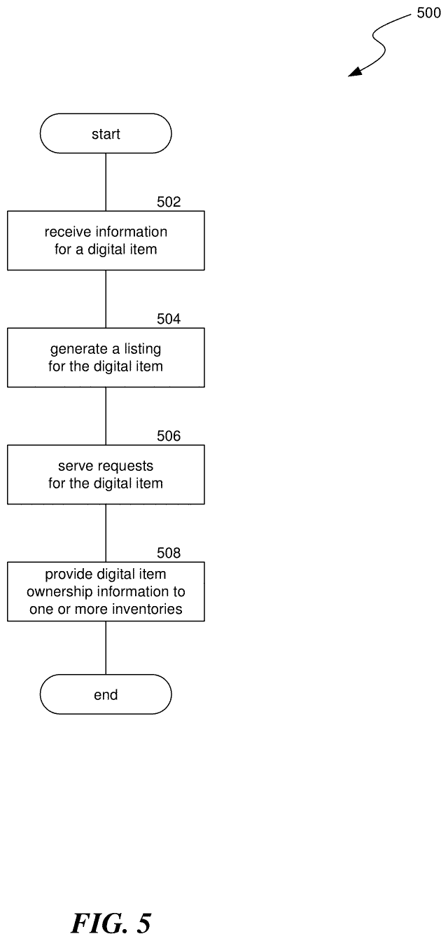

The listing generator 354 can receive digital item information from a publisher entity, via interfaces 352, can obtain additional details and/or assets for the digital item from the publisher and/or a CDN set of the digital item, and can generate a listing through which users can acquire ownership of the digital item. Additional details on creating listings for digital items are provided below in relation to blocks 502 and 504 of FIG. 5.

The acquisition transaction servicer 356 can, via the listing generated by the listing generator 354, perform acquisition transactions for the digital item which can include actions such as completing financial transactions and providing ownership rights to the user (e.g., via an inventory entity). Additional details on performing acquisition transactions are provided below in relation to blocks 506 and 508 of FIG. 5.

In FIG. 3C, specialized components 360, for an inventory entity, can include ownership registration module 364, environment authorization manager 366, inventory provider 368, and components which can be used for providing user interfaces, transferring data, and controlling the specialized components, such as interfaces 362.

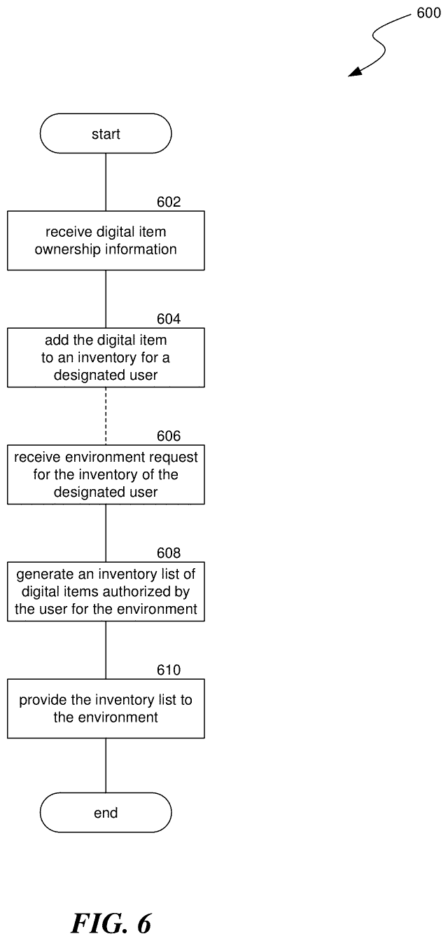

The ownership registration module 364 can receive digital item ownership information from a marketplace entity, via interfaces 362, and can update an inventory for an indicated user to include the indicated digital item. Additional details on adding items to a user's inventory are provided below in relation to blocks 602 and 604 of FIG. 6.

The environment authorization manager 366 can receive instructions or rules, from a user, specifying which ecosystems, environment types, or particular environments can have access to which items in the user's inventory. Additional details on setting inventory access controls are provided below in relation to blocks 604 and 608 of FIG. 6.

The inventory provider 368 can receive an inventory list request for a user, from an environment entity via interfaces 362, and can provide a list of items that match the ecosystem type of the environment and that the user has authorized to be provided to the ecosystem, environment type, or environment. Additional details on responding to inventory requests are provided below in relation to blocks 606-610 of FIG. 6.

In FIG. 3D, specialized components 370, for an environment entity, can include inventory acquisition module 374, digital item validator 376, digital item instantiator 378, artificial reality environment manager 380, and components which can be used for providing user interfaces, transferring data, and controlling the specialized components, such as interfaces 372.

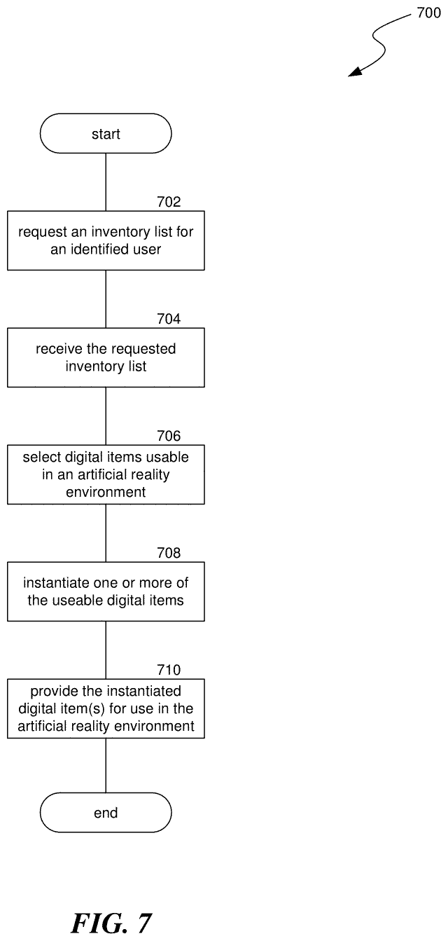

The inventory acquisition module 374 can interface with an inventory entity and a CDN entity, via interfaces 372, to acquire digital item data structures and assets owned by a give user. Additional details on acquiring an inventory of a user are provided below in relation to blocks 702 and 704 of FIG. 7.

The digital item validator 376 can determine whether each digital item acquired by the inventory acquisition module 374 can be used in the artificial reality environment of the current environment entity. This can include evaluations of technical compatibility, thematic compatibility, and/or functional compatibility. Additional details on verifying the useability of inventory items in an artificial reality environment are provided below in relation to block 706 of FIG. 7.

The digital item instantiator 378 can generate the version of digital items that can be output in the current artificial reality environment, e.g., rendering assets, executing constructor functions, defining constraints, setting placements and configurations, etc. Additional details on instantiating digital items are provided below in relation to blocks 708 and 710 of FIG. 7.

The artificial reality environment manager 380 can provide and manage an artificial reality environment, including tasks such as managing communications between digital items, tracking user actions, triggering events, tracking real-world objects, etc. Embodiments of the disclosed technology, such as artificial reality environment manager 380, may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

In some implementations, the sets of components in any of FIGS. 3A-3D can be in a computing system that is distributed across multiple computing devices or can be an interface to a server-based application executing one or more of the specialized components. Although depicted as separate components, each set of specialized components may be logical or other nonphysical differentiations of functions and/or may be submodules or code-blocks of one or more applications.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 4 is a flow diagram illustrating a process 400 used in some implementations for a publisher entity to create and administer digital items for a metaverse. Process 400 can be performed on a network system comprising one or more computing devices of a publisher entity (e.g., server and/or client devices). Process 400 can be initiated as part of an on-demand service, ready to accept digital item definitions when a creator logs into a digital item creation platform. A “creator” is a user or other entity that specifies the elements (e.g., assets, meta-data, functions, etc.) of a digital item to a publisher. A “publisher” is an entity that creates digital item data structures, based on creator input, and causes the digital item's assets to be available through a CDN (of its own or through contracts with another provider). By divorcing the creation process from the publishing, marketplace listing, inventory, and artificial reality environment, the creator is free to make digital items without having to know who the end user is (and vice versa) and without having to establish their own publishing and listing systems.

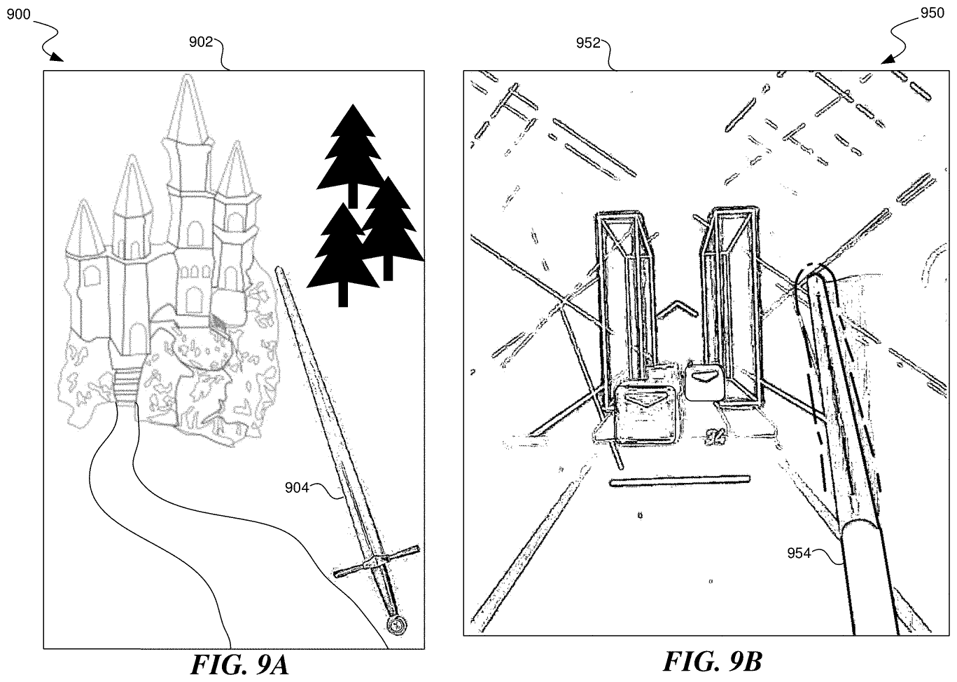

At block 402, process 400 can receive a digital item definition from a creator. The digital item definition can include assets for the digital item such as 3D models, 2D images, audio, animations, textual elements, scripts and code that define digital item actions, and other content items that can define output in relation to the digital item. The digital item definition can also include digital item meta data such as a title, description, sample images or screenshots, price, creator ID, which metaverse ecosystems the digital item is compatible with, qualifications on who can obtain the digital item or how the digital item can be obtained, uses of the digital item, size or positioning characteristics or constraints of the digital item, etc. In some cases, the digital item can be defined to be used in multiple different ecosystems, and the creator can provide alternate assets and/or metadata for different ecosystems or for individual environments within an ecosystem. For example, a first ecosystem implemented by company A may specify that digital items all have descriptions that include a link to a social media page while a second ecosystem implemented by company B may specify that digital items all have pain text digital item descriptions; in which case the creator can provide alternate description metadata complying with the policies of each ecosystem, allowing her digital item to be instantiated in each. As another example, a first artificial reality environment in an ecosystem may have a medieval theme while another environment in the ecosystem may have a futuristic theme; in which case the creator may specify different assets for a sword digital item, so it displays itself as a broadsword when in environments with a medieval type and displays itself as a laser-based sword when in environments with a futuristic type (see e.g., FIG. 9).

At block 404, process 400 can generate one or more versions of the digital items by applying the digital item definition to one or more templates. A set of templates can be defined for each ecosystem, whereby plugging data from the digital item definition into the set of templates and/or executing functions from the set of templates generates a digital item data structure and asset set for that ecosystem. The digital item definition can specify which ecosystems the digital item is intended to be used in, and/or process 400 can select a default one or more ecosystems, and corresponding template sets can be used at block 404 to generate the digital item data structures and assets. Process 400 can also generate additional metadata for the digital item data structure, such as a creation timestamp, producer ID, globally unique identifier (GUID—which may include a producer portion and a digital item portion), various hash values, security certificates, etc.

At block 406, process 400 can validate the digital item for one or more metaverse ecosystems and at block 408, process 400 can perform safety checks for the digital item. The validation and can include running a series of sample interactions with the generated digital item to make sure it conforms to policies specified by an ecosystem, such as correctly responding to close and open commands, correctly addressing privacy policies, handing various kinds of input and contexts without crashing or causing other types of volatility, having appropriate API interfaces, passing security checks, etc. The safety checks can analyze the various types of output the digital item can provide against machine learning models trained, for example, to identify obscenity, hate speech, lude content, etc. For each ecosystem a version of the digital item is configured to operate in, the ecosystem can provide a set of validation and safety check policies and procedures, and process 400 can implement those policies and procedures against the corresponding digital item version.

At block 410, process 400 can establish assets for the digital item in one or more content distribution networks (“CDNs”). A content distribution network can store assets indexed to a give digital item (and in some implementation also to a particular ecosystem) and can provide the assets for a digital item (and for a given ecosystem) when an environment requests them for instantiation. In various implementations, a producer entity can also provide the CDN for the digital items it produces, or the producer can use a third party CDN system to host these assets—providing a link to that CDN in the digital item data structure. At block 400, process 400 can cause the assets, received at block 402 for the instant digital item, to be indexed in its associated CDN. The CDN will then serve future requests for such digital item assets.

At block 412, process 400 can send the digital item to one or more marketplaces for listing. Process 400 can send the digital item to one or more default marketplaces, to one or more marketplaces defined for the ecosystems in which the digital item can be used, to one or more marketplaces selected by the creator, to one or more marketplaces selected based on features of the digital item (e.g., based on a mapping of A) digital item characteristics such as ecosystem compatibility, use case, type, etc. to B) marketplaces—where such a mapping may be based on historical sales performances for digital item characteristics), etc. In various implementations, the marketplace can define what information it needs to create a listing, and only these portions of the digital item data structure are provided, such as the digital item's GUID, title, compatible ecosystems or environments, cost, creator ID, certain assets (e.g., example image or screenshot), description, etc. After the digital item information is sent to one or more marketplaces, process 400 can end.

FIG. 5 is a flow diagram illustrating a process 500 used in some implementations for a marketplace entity to list digital items for a metaverse. Process 500 can be performed on a network system comprising one or more computing devices of a marketplace entity (e.g., server and/or client devices). Process 500 can be initiated as part of an on-demand service, ready to receive digital item information from various publishers, create listings, and serve user acquisition transactions for the listed digital items.

At block 502, process 500 can receive information for a digital item from a publisher. This digital item information can include the data sent by a publisher, e.g., at block 412 of process 400. For example, the digital item information can be provided through a call to an API or web interface, providing parameters the marketplace has specified as useable for a listing, such as a digital item identifier (GUID), title, description, screenshot, creator ID, compatible ecosystems, etc.

At block 504, process 500 can generate a listing for the digital item. A listing can be prepared for various mediums such as a digital item store app, a website, an XR store environment, etc. Each marketplace can have its own template for a digital item listing, but may include data such as the digital item title, description, where the digital item can be used (and what functionality the digital item will have in various ecosystems or environments), who can acquire the digital item, the digital item's cost (if any), screenshots, models, etc. In some implementations, at block 504, process 500 can acquire some of the information needed from a listing from the publisher of the digital item or from a CDN listed in the digital item information. For example, the information received at block 502 may specify a GUID (with a publisher identifier and a digital item identifier) and process 500 can access an API of the publisher and/or CDN to acquire the digital item assets and data needed for its listing of the digital item. The marketplace can provide the created listing through the various mediums for which it was created.

At block 506, process 500 can serve requests for the digital item. For example, as users access the mediums hosting the digital item listing, the users may click an acquire button, drag the item into the artificial reality environment, etc. to initiate an acquisition transaction. In various implementations, the transaction can include providing ownership information for the digital item and may be predicated on completion of a financial transaction (e.g., confirmation that a cost for the digital item was paid, which may include providing portions of the cost to the publisher, creator, or other stakeholders).

At block 508, process 500 can provide digital item ownership information to one or more inventories. This can include providing an identifier of the digital item (and of the publisher if not embedded in the digital item identifier) and an identifier of the acquiring user to an inventory entity. The inventory entity can be an inventory specified by the acquiring user (e.g., during the acquisition transaction, the user can specify which inventory service they use), can be a globally default inventory service, or an inventory service default for each ecosystem in which the digital item is compatible. Once the inventory for the acquiring user has been updated, process 500 can end.

FIG. 6 is a flow diagram illustrating a process 600 used in some implementations for an inventory entity to provide ownership data for digital items for a metaverse. Process 600 can be performed on a network system comprising one or more computing devices of an inventory entity (e.g., server and/or client devices). Process 600 can be initiated as part of multiple on-demand services, a first service ready to register a digital item as owned by a particular user and a second service ready to respond to requests for lists of digital items owned by a given user.

At block 602, process 600 can receive digital item ownership information. In various implementations, the digital item ownership information can be the result of an acquisition transaction between a user and a marketplace (e.g., provided at block 508 of process 500), can be proof of ownership provided directly from a user (e.g., a certificate, NFT, access key, etc.), or can be provided directly by a publisher (e.g., when a publisher automatically assigns ownership to a group of users as a give-away, benefit for an accomplishment, promotion, etc.) The digital item ownership information can include an identifier for the user for whom the digital item ownership is being established, an identifier for the digital item, the digital item data structure (unless it is hosted by a publisher or CDN), and/or an identifier for the publisher and/or CDN holding the assets for the digital item (unless that identifier is embedded in the digital item identifier).

At block 604, process 600 can add the digital item to an inventory of a designated user. This can include setting a cross-reference, e.g., in a database between the user identifier and the digital item identifier. In some implementations, the user can provide additional classifications and qualifiers for the inventory, such as what ecosystems, environment types, or specific environments are authorized to be notified of the user's ownership of the object. For example, if a user's digital item was a recreation of her burning man outfit, she may authorize that digital item to be shared with environment types she's classified as being for her friends but may exclude such authorization from environment types she has associated with her work.

The connection separating block 604 and 606 is shown as a dashed line to illustrate that block 606 may not follow directly from block 604. Instead, blocks 602 and 604 may be steps that occur following receipt of a digital item registration request whereas blocks 606-610 may be steps that occur following receipt of an environment requesting an inventory list for a given user. Thus, at block 606, process 600 can receive the request from an environment for the inventory of the designated user—e.g., providing the user's identifier and details about the environment the inventory may need e.g., to select which inventory items are compatible with that environment and that the user has authorized to be identified to the environment.

At block 608, process 600 can generate an inventory list of digital items authorized by the user for the environment. The inventory list can be filtered according to user-defined rules and/or access lists. For example, as discussed above, a user can set rules that specify ecosystems or environment characteristics that allow or disallow certain environments to receive identifications of some of that user's digital items. As another example, a user can make inventory lists and assign them to particular environments, so the user comes into that environment outfitted as desired. In yet further cases, the user can set which characteristics, filters, or modifications for individual digital items are to be used in various ecosystems, environment types, or specific environments. In some implementations, this list can be further filtered to only provide digital items that are compatible with the ecosystem of the requesting environment. At block 610, process 600 can provide the inventory list generated at block 608 to the requesting environment, after which process 600 can end.

FIG. 7 is a flow diagram illustrating a process 700 used in some implementations for an environment entity to instantiate digital items into an artificial reality environment for a metaverse. Process 700 can be performed on an environment entity such as an artificial reality device or one or more computing devices providing services to such an artificial reality device (e.g., server and/or client devices). Process 700 can be initiated in response to a user entering an artificial reality environment via the artificial reality device, e.g., to load the user's inventory items into the artificial reality environment.

At block 702, process 700 can obtain an inventory list, from an inventory entity, for an identified user. The user can be identified by logging into her account on an artificial reality device, providing another authentication key, or by the artificial reality device recognizing the user (e.g., via face recognition or another biometric authentication). The user can be associated with one or more inventory services (e.g., in her account, through a selection, by a user-to-inventory registration service, or by a default inventory for all users), which process 700 can access to get a handle (e.g., IP address, URL, API interface, etc.) to query one or more inventory entities. Process 700 can then use the inventory handle to send request for an inventory list, to the one or more inventory entities, identifying the user. At block 704, process 700 can receive the requested inventory list from the inventory entity. This can be the list sent at block 610 of process 600. If multiple inventory lists are received from multiple inventory entities, blocks 704-710 can be performed for each.

At block 706, process 700 can evaluate the items on the inventory list to select one or more authorized digital items usable in the artificial reality environment. This can include evaluating properties of each item in the inventory to determine if the item is compatible with the artificial reality environment. Such compatibility determination can include evaluations of technical compatibility, thematic compatibility, and/or functional compatibility. In some cases, a compatibility determination may require first acquiring the digital item data structure and/or digital item assets from the digital item's publisher and/or CDN. Process 700 can determine technical compatibility by evaluating a set of validations on the digital item data structure, such as checking whether the digital item has been created, by a publisher, for the ecosystem of the current artificial reality environment, checking whether the digital item has a minimum set of required interfaces for the artificial reality environment, testing instantiation routines of the digital item for the artificial reality environment, etc. Process 700 can determine thematic compatibility by checking assigned types of the digital item (e.g., time period, clothing style, genre, etc.) and/or by applying a machine learning model trained to evaluate digital item assets to generate thematic tags and determining whether the tags match the theme of the current artificial reality environment. In some implementations, the thematic compatibility by checking can include checking a version of the digital item matching a version of the environment. For example, the digital item may have a version of assets for environments set in the 1800s and a version for environments set in outer space, and process 700 can perform thematic combability for the version best matching the artificial reality environment. In some cases, determining thematic compatibility can further include applying a machine learning model trained to evaluate digital item assets to determine whether the assets show offensive, lude, or hateful content, so artificial reality environments that disallow this type of content can filter out these digital items. Process 700 can determine functional compatibility by evaluating parameters of the digital item to determine whether functional aspects of the digital item are allowed in the artificial reality environment. This can include evaluating how the digital item can be sized, where it can be placed, and how it can affect other objects in the artificial reality environment. When disallowed functional elements are found, process 700 may exclude the digital item from being instantiated in the artificial reality environment or may eliminate those functional elements from the digital item.

At block 708, process 700 can instantiate one or more of the useable digital items. Instantiating the digital item can include obtaining the digital item's assets from the CDN listed for the digital item (if not already retrieved at block 706). Instantiating the digital item can include establishing the models for the digital item to load into the artificial reality environment and setting functional properties of the digital item. This instantiation process can result in different versions of the digital item for different environments. For example, the rendering process can include applying a thematic filter to the digital item's assets to make them fit into the theme of the artificial reality environment, selecting the version of the digital item (defined by the digital item creator) matching the theme of the artificial reality environment, setting a resolution level for the digital item, etc. As another example, the functional setup of the digital item in the instantiation process can eliminate functions of the digital item that are incompatible with the artificial reality environment or can adjust such functions, such as by setting size limits, placement limits, range limits, etc. on the digital item.

At block 710, process 700 can provide the instantiated one or more digital items to the user for use in the artificial reality environment. After providing the instantiated one or more digital items, process 700 can end.

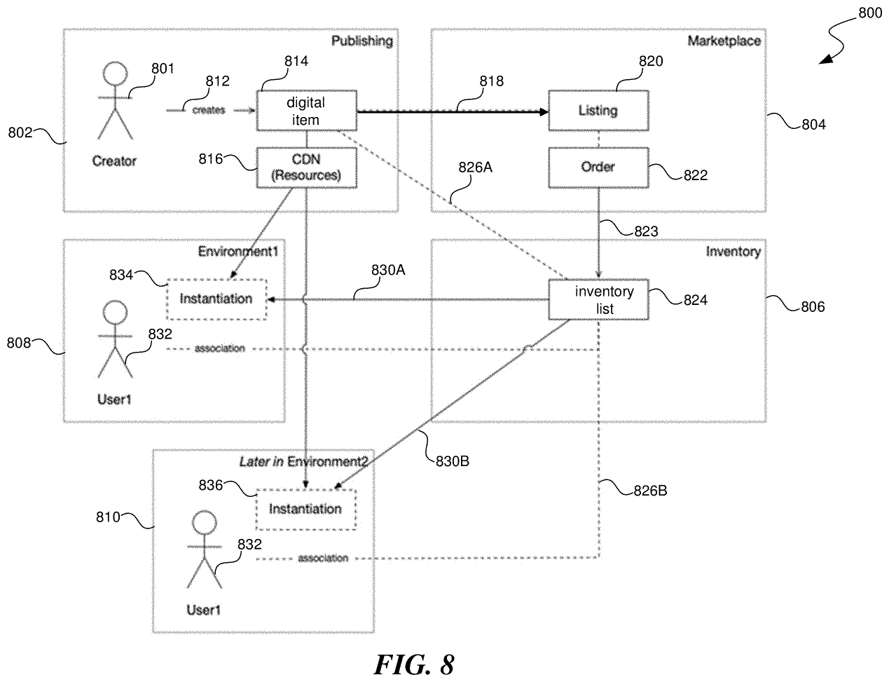

FIG. 8 is a conceptual diagram illustrating an example 800 of interactions between publishing, marketplace, inventory, and environment entities for digital items in a metaverse. Example 800 includes a creator user 801, a publishing entity 802, a marketplace entity 804, an inventory entity 806, and two environment entities 808 and 810 hosting users such as user 832. In example 800, the creator 801 sends a digital item definition and assets, at 812, to the publishing entity 802, which validates it and creates the digital item 814 with its assets stored in CDN 816. At 818, information for the digital item is sent to the marketplace entity 804, which marketplace entity 804 uses to create a listing 820, which in turn fills orders (i.e., user acquisition transactions) 822. At 823, the acquisitions by the user are recorded with the inventory entity 806, where the recording includes making an association 826A and 826B between the digital item 814 and the user 832. When the user 832 enters a first environment 808, the environment 808 obtains at 830A the inventory list 824 (via the associations 826) from the inventory entity 806, which it authorizes and instantiates at 834. Later, when the user 832 enters a second, different environment 810, the environment 810 obtains at 830B the inventory list 824 (again via the associations 826) from the inventory entity 806, which it also authorizes and instantiates at 836. In each case, the user 832 is able to use the digital item 814, acquired from the creator 801 via publisher 802 and marketplace 804, in different environments of a metaverse 808 and 810.

FIGS. 9A and 9B are conceptual diagrams illustrating examples 900 and 950 of a digital item instantiated in two different artificial reality environments in a metaverse. In example 900, an artificial reality environment 902 is shown which has a medieval theme. In this instance, a digital item has been instantiated as a broadsword version 904, where the assets selected when rendering the digital item are for a type set (by the digital item creator) for the medieval time period. In example 950, an artificial reality environment 952 is shown which has a sci-fi theme. In this instance, the same digital item from example 900 has been instantiated as a laser sword version 954, but in this instance the assets selected when rendering the digital item are for a type set (by the digital item creator) matching a sci-fi theme. Thus the same digital item, owned by the same user and from the same creator, is rendered in different environments or the user with properties matching that environment.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for producing a digital item for use in multiple environments of a metaverse, the method comprising:
receiving a digital item definition specifying A) characteristics of the digital item including multiple metaverse ecosystems in which the digital item can be used and B) assets for the digital item;
producing a digital item data structure by applying, for each particular metaverse ecosystem of the multiple metaverse ecosystems, portions of the digital item definition to a set of one or more templates defined for the particular metaverse ecosystem;
establishing the assets of the digital item in a content distribution network, wherein the content distribution network provides at least some of the assets of the digital item to at least an environment in response to queries identifying the digital item; and
sending information for the digital item to one or more marketplaces;
wherein, in response to the sending the information, the one or more marketplaces each establish a listing for the digital item used in an acquisition transaction for the digital item to a user;
wherein the acquisition transaction provides ownership information for the digital item to an inventory entity; and
wherein at least one of the multiple environments communicate with the inventory entity to obtain the ownership information, access the content distribution network to obtain the assets of the digital item, and instantiate the digital item in an artificial reality environment.

2. The method of claim 1, wherein the characteristics of the digital item further include: a title, a description, a creator ID, uses of the digital item, and size and/or positioning characteristics or constraints of the digital item.

3. The method of claim 1,
wherein at least two of the multiple metaverse ecosystems have different entities that implemented artificial reality environments of each of the at least two metaverse ecosystems; or
wherein at least two of the multiple metaverse ecosystems use different digital item data structure standards.

4. The method of claim 1 further comprising validating the digital item for the multiple metaverse ecosystems by one or more of:
performing one or more sample interactions with the digital item and confirming the digital item's output conforms to policies specified by an ecosystem;
performing privacy policy validations against the digital item;
validating that the digital item includes a defined set of API interfaces; or
any combination thereof.

5. The method of claim 1, wherein the sending information for the digital item to one or more marketplaces includes sending the information for the digital item to multiple marketplaces that each establish a listing for the digital item used in acquisition transactions for the digital item to a user.

6. The method of claim 1, wherein the one or more marketplaces establish a listing for the digital item that lists at least a title for the digital item, a description of the digital item, and indications of the multiple metaverse ecosystems in which the digital item can be used.

7. A computer-readable storage medium storing instructions that, when executed by a computing system, cause the computing system to perform a process for producing a digital item for use in multiple environments of a metaverse, the process comprising:
receiving a digital item definition specifying A) characteristics of the digital item including multiple metaverse ecosystems in which the digital item can be used and B) assets for the digital item;
producing a digital item data structure by applying, for each particular metaverse ecosystem of the multiple metaverse ecosystems, portions of the digital item definition to a set of one or more templates defined for the particular metaverse ecosystem;
establishing the assets of the digital item in a content distribution network, wherein the content distribution network provides at least some of the assets of the digital item to at least an environment in response to queries identifying the digital item; and
sending information for the digital item to one or more marketplaces;
wherein, in response to the sending the information, the one or more marketplaces each establish a listing for the digital item used in an acquisition transaction for the digital item.

8. The computer-readable storage medium of claim 7, wherein the acquisition transaction provides ownership information for the digital item to an inventory entity.

9. The computer-readable storage medium of claim 8, wherein at least one of the multiple environments communicate with the inventory entity to obtain the ownership information, access the content distribution network to obtain the assets of the digital item, and instantiate the digital item in an artificial reality environment.

10. The computer-readable storage medium of claim 7, wherein the sending information for the digital item to one or more marketplaces includes sending the information for the digital item to multiple marketplaces that each establish a listing for the digital item used in acquisition transactions for the digital item.

11. The computer-readable storage medium of claim 7, wherein the one or more marketplaces establish a listing for the digital item that lists at least a title for the digital item, a description of the digital item, and indications of the multiple metaverse ecosystems in which the digital item can be used.

12. The computer-readable storage medium of claim 7, wherein the characteristics of the digital item further include: a title, a description, a creator ID, uses of the digital item, and constraints of the digital item.

13. The computer-readable storage medium of claim 7, wherein at least two of the multiple metaverse ecosystems use different digital item data structure standards.

14. The computer-readable storage medium of claim 7, wherein the process further comprises validating the digital item for the multiple metaverse ecosystems by:
performing one or more sample interactions with the digital item and confirming the digital item's output conforms to policies specified by an ecosystem; and
performing privacy policy validations against the digital item.

15. A computing system for producing a digital item for use in multiple environments of a metaverse, the computing system comprising:
one or more processors; and
one or more memories storing instructions that, when executed by the one or more processors, cause the computing system to perform a process comprising:
receiving a digital item definition specifying A) characteristics of the digital item including multiple metaverse ecosystems in which the digital item can be used and B) assets for the digital item;
producing a digital item data structure by applying, for each particular metaverse ecosystem of the multiple metaverse ecosystems, portions of the digital item definition to a set of one or more templates defined for the particular metaverse ecosystem;
establishing the assets of the digital item in a content distribution network, wherein the content distribution network provides at least some of the assets of the digital item to at least an environment in response to queries identifying the digital item; and
sending information for the digital item to one or more marketplaces.

16. The computing system of claim 15, wherein, in response to the sending the information, the one or more marketplaces each establish a listing for the digital item used in an acquisition transaction for the digital item.

17. The computing system of claim 16, wherein the acquisition transaction provides ownership information for the digital item to an inventory entity.

18. The computing system of claim 17, wherein at least one of the multiple environments communicate with the inventory entity to obtain the ownership information, access the content distribution network to obtain the assets of the digital item, and instantiate the digital item in an artificial reality environment.

19. The computing system of claim 15, wherein at least two of the multiple metaverse ecosystems have different entities that implemented artificial reality environments of each of the at least two metaverse ecosystems.

20. The computing system of claim 15, wherein at least two of the multiple metaverse ecosystems use different digital item data structure standards.
